(19) United States
(12) Patent Application Publication
(10) Pub. No.: US 2014/0189356 A1
(43) Pub. Date: Jul. 3, 2014

(54) METHOD OF RESTRICTING CORPORATE DIGITAL INFORMATION WITHIN CORPORATE BOUNDARY

(71) Applicants: Vinay Phegade, Beaverton, OR (US); Jason Martin, Beaverton, OR (US); Reshma Lal, Portland, OR (US); Micah Sheller, Hillsboro, OR (US); Tobias Kohlenberg, Portland, OR (US)

(72) Inventors: Vinay Phegade, Beaverton, OR (US); Jason Martin, Beaverton, OR (US); Reshma Lal, Portland, OR (US); Micah Sheller, Hillsboro, OR (US); Tobias Kohlenberg, Portland, OR (US)

(73) Assignee: Intel Corporation, Santa Clara, CA (US)

(21) Appl. No.: 13/976,023

(22) PCT Filed: Dec. 29, 2011
(86) PCT No.: PCT/US11/67878

§ 371 Date: Jun. 25, 2013

(51) Int. Cl. H04L 29/06

(52) U.S. Cl. CPC H04L 63/062
USPC 713/171

(57) ABSTRACT

A method of enforcing a virtual corporate boundary may include a client device requesting sensitive content from a network site on a server device responsive to a user's interaction with the client device. The server device can determine whether the user and/or client device are permitted to access the sensitive content. A secure element on the client device can establish a session key between the server device and the client device. The server device can render the sensitive content and send it to the client device, which can display the content to the user.

### TECHNICAL FIELD

The disclosed technology relates generally to data security and, more particularly, to techniques for preventing sensitive information leakage from a user endpoint while enforcing an organization's data use policies.

### BACKGROUND

In order to stay informed, connected, and productive in their professional lives as well as their personal lives, employees tend to use a number of popular, yet diverse, products such as smartphones and tablet computing devices to access and take advantage of any of a number of social networking and instant messaging technologies. These products, and the applications associated therewith, can be challenging to an information technology (IT) group, particularly since employees increasingly want to use their favorite mobile device for both personal and professional use. That is, users tend to store personal data and install Internet-based games on the same devices that can be used to access enterprise applications and data

User demand for an always-on environment with anytime/anywhere access has been fundamentally changing support and service requirements. Indeed, these consumer technologies and tools are effectively breaking down traditional IT barriers. The benefits of corporate information sharing on open client based channels often results in undesirable information leakage when employees and other users bring their personal devices, e.g., iPads, into certain areas, regardless of whether they have permission to do so. Comingling of personal and corporate applications heightens risk to data. While the primary concern is often email, there are many other target areas such as web access, file sharing, and social media that uses the web to share data. Also, companies often experience an increase in targeted phishing and corporate espionage attacks by cybercriminals and insider threats taking advantage of such comingling.

Current attempts to monitor, track, and police sensitive data during rest and transit as it moves throughout an organization, including to destinations outside of the enterprise, tend to run into a number of limitations, such as malicious data movement that bypasses and IT department's visibility, e.g., advanced persistent threats such as Aurora, copying to USB devices as in Wiki-leaks, etc. Also, data typically needs to be decrypted at an end user's platform during viewing, where it often becomes vulnerable to various threats, e.g., screen scraping tools. Such attempts are not without an impact on both performance and usability. For example, in order to protect data, an IT group may run a number of policing software applications and suites such as antivirus (AV) software, firewall(s), host-based intrusion protection systems (RIPS), file integrity monitoring (FIM) applications, application control, encryption, etc. However, all of these protective measures may consume the client device's processing capability and battery power. Also, because of changing regulatory environments, compliance with such can be expensive.

### BRIEF DESCRIPTION OF THE DRAWINGS

Embodiments of the disclosed technology are illustrated by way of example, and not by way of limitation, in the drawings and in which like reference numerals refer to similar elements.

FIG. 1 is a block diagram illustrating an example of a typical environment in which embodiments of the disclosed technology may be implemented.

FIG. 2 is a block diagram illustrating a first example of a secure system in accordance with embodiments of the disclosed technology.

FIG. 3 is a block diagram illustrating a second example of a secure system in accordance with embodiments of the disclosed technology.

FIG. 4 is a flowchart illustrating a first example of enforcing a virtual corporate boundary implementing a virtual corporate boundary in accordance with embodiments of the disclosed technology.

FIG. 5 is a flowchart illustrating a second example of enforcing a virtual corporate boundary implementing a virtual corporate boundary in accordance with embodiments of the disclosed technology.

### DETAILED DESCRIPTION

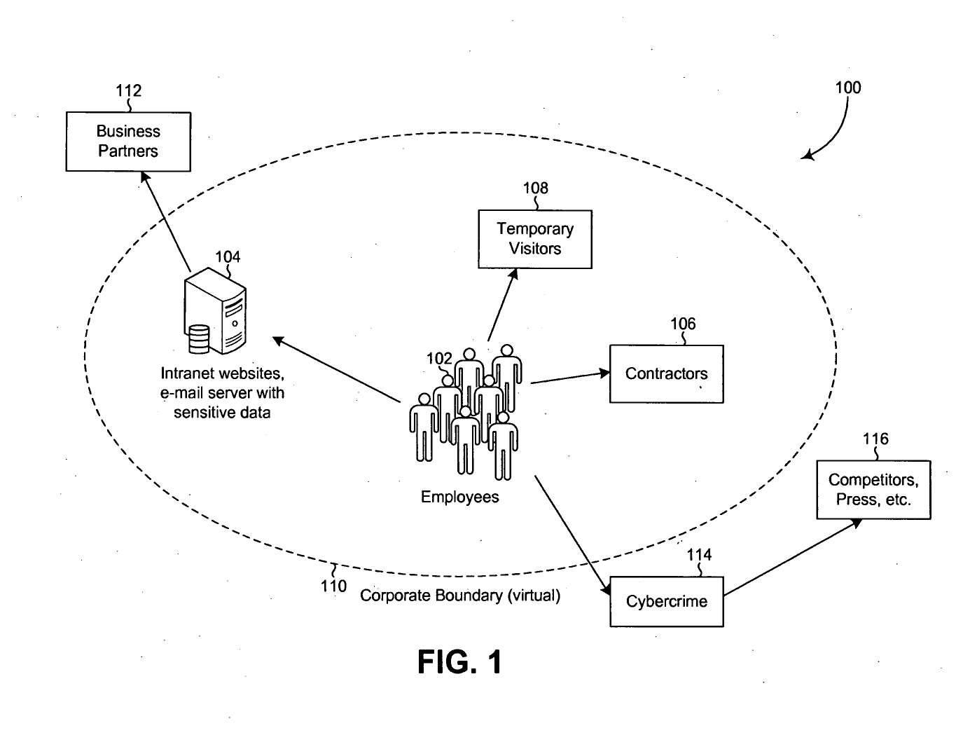

FIG. 1 is a block diagram illustrating an example of a typical environment 100 in which embodiments of the disclosed technology may be implemented. In the example, a company has various employees 102 that may access company resources 104 such as intranet websites, email servers, and any of a number of devices or applications storing or facilitating access to sensitive data, information, content, or any combination thereof. The employees 102 may work with any of a number of contractors 106 and/or temporary visitors 108 that may be allowed to enter company premises during the course of normal business operation. However, the company may not want to provide the contractors 106 or temporary visitors 108 with certain access, be it full or even limited or restricted, to the company resources 104.

In the example, a virtual corporate boundary 110 is implemented to protect the company resources 104 and, more particularly, sensitive data stored thereon from cybercriminals 114 who seek to access and/or disrupt such data. Should the cybercriminals 114 access or copy any of the sensitive data stored by the company resources 104, they may then seek to sell or otherwise transfer such data or information to third parties 116 such as competitors, the press, etc. Alternatively or in addition thereto, there may be business partners 112 to whom the company would like to send certain data or information or provide with access to such data, which may include sensitive data.

Embodiments of the disclosed technology may provide companies or groups such as information technology (IT) departments with capabilities and greater control to overcome the many limitations of current attempts at solutions. Embodiments may serve to protect corporate and/or sensitive digital content, such as text/documents, video, audio, etc., at the user endpoint, e.g., desktop or laptop computer, tablet computing device, or smartphone, such that an audit & access control server (AAS) cannot be bypassed.

For example, whenever a user accesses sensitive content, the user's identity and device may be authenticated by an IT department's AAS to ensure that access is limited to authorized users having an IT department-approved device, for example. The device may be owned by the IT department or it may be personal property of the user. Accordingly, the deployment of a bring-your-own-device (BYOD) model within a company may be facilitated and effectively maintained.

In certain embodiments where sensitive data or content is released to a user's device in an encrypted format, a key to decrypt the encrypted data may be provided by the IT department's AAS. In such embodiments, the sensitive data or content may always reside on the client device in the encrypted format. Such implementations may greatly reduce the risk of information leak should the user's laptop be stolen, for example.

In situations involving unauthorized copying of sensitive data or content by an unauthorized user and/or unauthorized device, implementations may interfere with or even prevent the content from being viewed, printed, etc. by the unauthorized user and/or device in the absence of an authentication and access check by the AAS. Consequently, in such embodiments, any attempted movement of sensitive data or content from device to device may not be able to bypass the IT department's AAS.

In certain implementations of the disclosed technology, the protection of sensitive data or content on a client device is orthogonal to vulnerabilities in other applications on the client device. As a result, the need for monitoring software and associated cost, performance, and. battery demands is reduced, often substantially. Such implementations may also result in greater employee flexibility with regard to devices of choice and consumerization.

In certain embodiments, additional watermarking may be added to data or content in order to discourage filming and distribution by malicious user, for example.

Implementations of the disclosed technology may include a secure element. As used herein, a secure element generally refers to a malware and/or hardware attack-resistant execution environment that may be used to attest to the remote party properties of the execution environment.

Implementations of the disclosed technology may also include a secure sprite. As used herein, a secure sprite refers to an ability to display bitmaps securely on the screen of a device such that it cannot be scraped from the screen by malware, for example. A secure sprite may include, but is not limited to, protected audio/video path (PAVP) and/or high bandwidth digital content protection (HDCP) techniques.

In certain embodiments, any of a number of authentication methods may be used for validating a user's identity. Such authentication techniques may be implemented individually or in combination as required by a data policy.

Embodiments of the disclosed technology may be implemented in any of a number of different ways depending on the capabilities of the secure element and the display protection technology, for example.

Consider an example in which a user named John needs to access certain acquisition-related documents from his company's intranet site strategy.acme.com. John has an IT-approved tablet device that has been provisioned with strong authentication technology. John has access to encrypted data that is shared on the intranet site strategy.acme.com about a planned acquisition. The documents in the repository are encrypted and released after authenticating user's identity & checking access permissions. As a result of a spear phishing attack, however, John's tablet device may now have a rootkit or other undesirable and/or malicious software thereon.

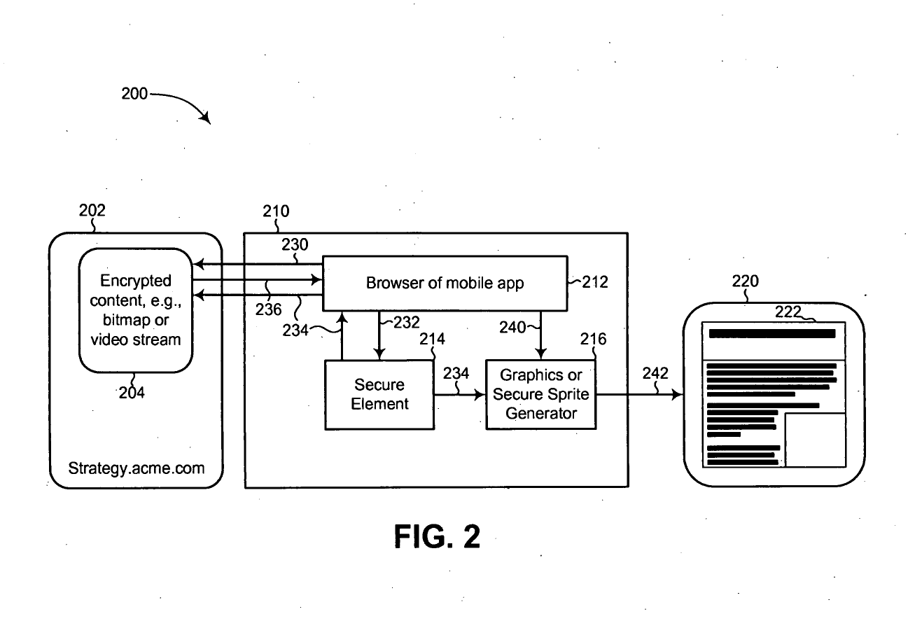

FIG. 2 is a block diagram illustrating a first example of a secure system 200 implementing a virtual corporate boundary in accordance with embodiments of the disclosed technology. The system 200 includes a network site 202, such as a company internal website or intranet, e.g., strategy.acme.com. The network site 202 may store encrypted content, information, or data 204, such as a bitmap file, video stream, or virtually any other type of data, content, or information that may be encrypted and stored on a machine such as a server.

The system 200 also includes a client device 210, such as a tablet computing device or smartphone. The client device 210 has associated therewith a display 220 for presenting information visually to the user. The display 220 may be integrated with the client device 210 or it may be situated remotely from the client device 210, e.g., connected to the client device 210 via a wireless connection.

In the example, a user is using the client device 210, which connects to the network site 202. Responsive to the user's interaction with the client device 210, e.g., using a web browser 212 or other application on the client device 210, the client device 210 may send a request for sensitive information, such as a sensitive document or content, from the network site 202, as indicated by 230.

The user's identity may be authenticated to the web application via any of a number of standard authentication methods. For example, on the server side, an access control system may be used to check that the user is permitted to access a particular acquisition document. Based on a positive result of the check, the server may then send a response to activate certain client protection features. For example, the web browser 212 may have an extension that invokes an application in a secure element 214, as indicated by 232.

In certain embodiments, a session key may be established, as indicted by 234. In the example, the secure element 214 verifies the identity of the network site 202 and then establishes an ephemeral protected audio/video path (PAVP) session key (Ks) between the web application on the network site 202 and a graphics chipset 216 on the client device 210. The session key Ks may be established over a secure channel that is established using a secret on the client device 210. In certain embodiments, this can be pre-provisioned. The client device 210 may inform the server of its capability and identity.

In the example, the server-side application may render the sensitive content 204 on the server, e.g., from .pdf, .doc, or other format, as indicated by 236. In the example, this rendered bitmap is encrypted using the session key Ks and is subsequently sent to the web browser 212 on the client device 210.

An extension of the web browser 212 on the client device 210 may send the encrypted content to the graphics chipset 216 on the client device 210, as indicated by 240, in order for the content to be presented to the user on the display 220 via high bandwidth digital content protection (HDCP), for example, as indicated by 242. The page 222 may then be displayed to the user in-line with the non-secure content on the display 220.

In certain embodiments, a client device may have scalable secure element capabilities such as a PAVP channel with graphics. In such embodiments, graphics to be displayed may be protected by a protective measure such as HDCP, for example. Sensitive content on a network such as a company intranet may be composed directly within a secure element and delivered to a graphics subsystem of the client device by the secure element.

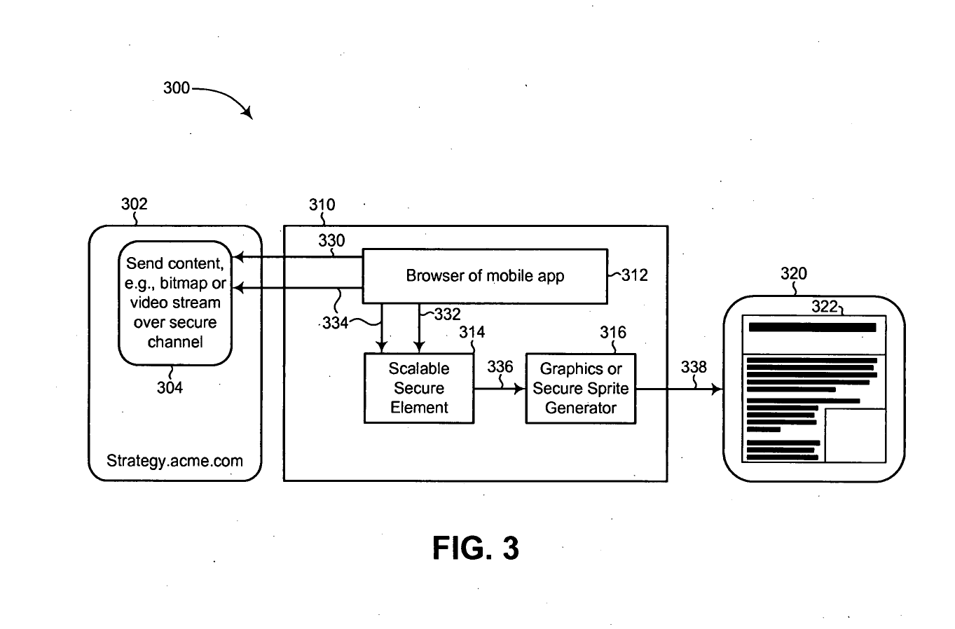

FIG. 3 is a block diagram illustrating a second example of a secure system 300 implementing a virtual corporate boundary in accordance with embodiments of the disclosed technology. In the example, the system 300 includes a network site 302, such as a company's intranet, and a client device 310, such as a handheld computing device, tablet device, or smartphone. As with the client device 210 of FIG. 2, the client device 310 of FIG. 3 has associated therewith a display 320 that may be integrated with or separate from the client device 310, e.g., connected to the client device 310 via a wireless connection.

In the example, a user needs to access the latest status on certain acquisition negotiations. Using his or her client device 310, such as a laptop or tablet computer or smartphone, the user connects to the company intranet 302 or other network site and sends a request for information or content 304 pertaining to the acquisition negotiations, as indicated by 330. The information requested may include sensitive documents or other types of information, data, or content.

Once a connection has been established at 330, an authentication and access check may be performed using a secure element 314, as indicated by 332. For example, the user's identity may be authenticated to a web application 312 or other application on the client device 310 via any of a number of known authentication techniques. On the server side, an access control system may confirm whether the user is permitted to access the requested acquisition document. The server may subsequently send a response to activate certain client protection features, and an extension of the web browser 312 on the client device 310 may invoke an application in the secure element 314.

In the example, a client-web application secure session key (Ks) may be established, as indicated by 334. The secure element 314 may verify the identity of the network site 302. Once the secure element 314 attests to the network site 302, it may establish an encrypted channel. between the web application on the network site 302 and the secure element 314. The web application on the network site 302 may send the sensitive content to the secure element 314 over an encrypted channel, e.g., using a secure socket layer (SSL) connection. The client device 310 may inform the server of its capability and identity.

The secure element 314 may establish an ephemeral PAVP session key (KS) for the graphics chipset 316 on the client device 310, as indicated by 336. The secure element 314 may utilize an application to render sensitive content, e.g., from .pdf or .doc format, on the client device 310.

In the example, the secure element 314 may encrypt a rendered bitmap using the session key (Ks) and send the resulting data to the graphics chipset 316 on the client device 310, as also indicated by 336, for secure display to the user on the screen 320 via HDCP, for example, as indicated by 338.

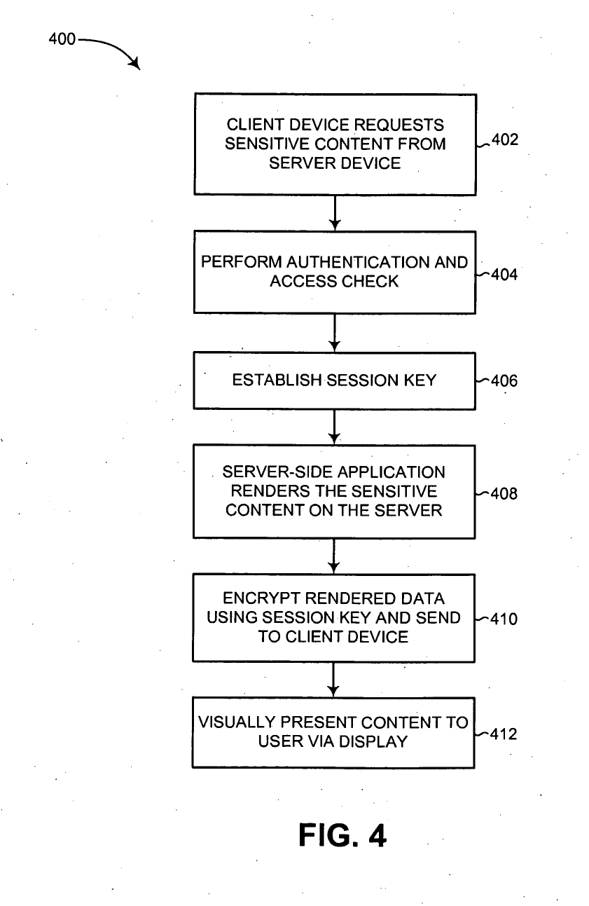

FIG. 4 is a flowchart illustrating a first example 400 of enforcing a virtual corporate boundary in accordance with embodiments of the disclosed technology. At 402, a user uses a client device, such as a tablet computing device, to request sensitive data from a network site such as the user's company intranet. The requested data may include any of a number of data types, file formats, multimedia content, etc.

At 404, an authentication and access check is performed. For example, a server-side access control system may perform a check to determine whether the user and/or client device is permitted to access the requested information. Upon a determination that such authorization exists, the server may send a response to activate client protection features and the web browser application on the client device may invoke an application in a secure element on the client device.

At 406, a session key is established. For example, the secure element on the client device may verify the identity of the network site and establish a session key, e.g., a PAVP session key, between a web application on the server device and the graphics chipset on the client device. The client device may inform the server of it capability and identity.

At 408, the server-side application renders the sensitive content on the server. The rendered data is encrypted using the session key and then sent to the browser application on the client device, as indicated at 410. A browser extension sends the encrypted content to the graphics chipset to be visually presented to a user via a display, as indicated at 412. The display may be integrated with or physically separate from the client device. The content may be displayed using a content protection technique, such as HDCP, such that the page is displayed to the user in-line with the non-secure content.

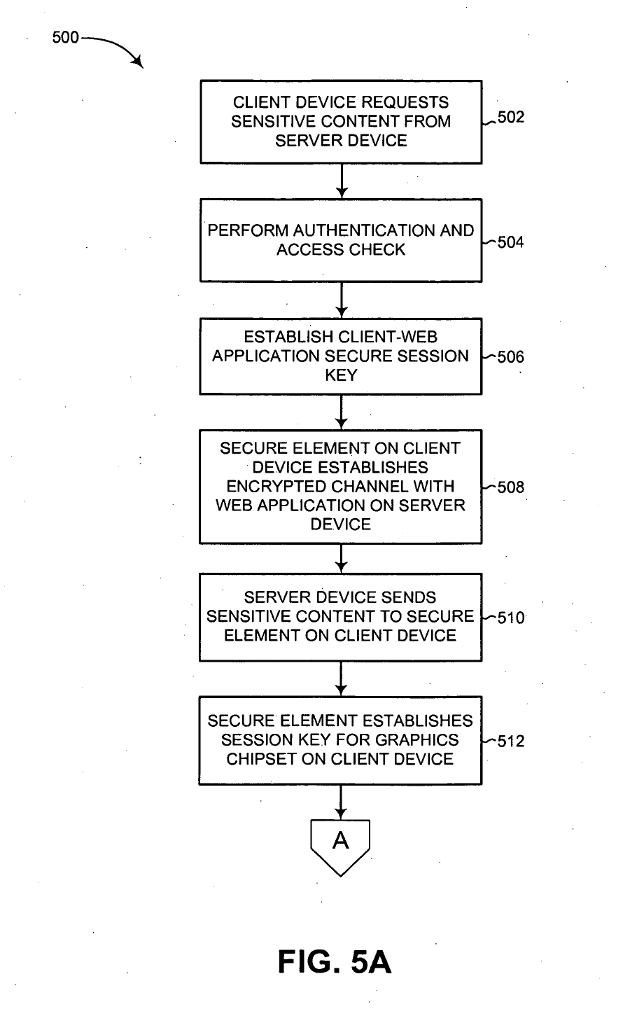

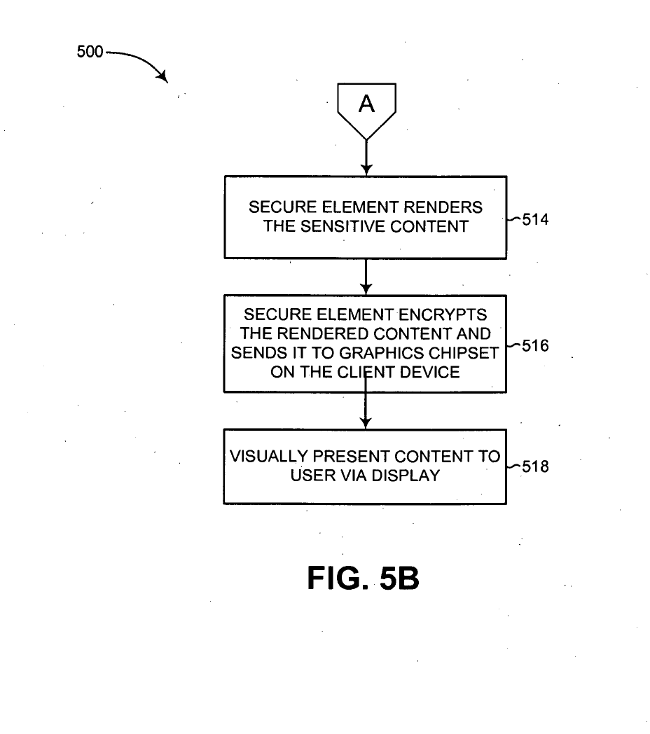

FIG. 5 is a flowchart illustrating a second example 500 of enforcing a virtual corporate boundary in accordance with embodiments of the disclosed technology. At 502, a user uses a client device, such as a tablet computing device, to request sensitive content from a network site such as the user's company intranet. At 504, an authentication and access check is performed. This is similar to the processing that occurs at 404 of the method 400 of FIG. 4.

At 506, a client-web application secure session key is established. For example, a secure element on the client device may verify the identity of the network site. The secure element on the client device establishes an encrypted channel between a web application on the server device and the secure element itself, as indicated by 508.

At 510, the web application on the server device sends the sensitive content to the secure element over the encrypted channel, e.g., using SSL. The client device may inform the server device of its capability and identity.

At 512, the secure element on the client device establishes a session key for the graphics chipset on the client device. The secure element then renders the sensitive content on the client device, as indicated by 514. The secure element encrypts the rendered content and sends it to the graphics chipset on the client device, as indicated by 516.

At 518, the content is visually presented to the user via a display. The display may be integrated with or physically separate from the client device. For example, the display may be connected to the client device via a wireless communication channel. The content may be displayed using a content protection technique such as HDCP.

Embodiments of the disclosed technology may be incorporated in various types of architectures. For example, certain embodiments may be implemented as any of or a combination of the following: one or more microchips or integrated circuits interconnected using a motherboard, a graphics and/or video processor, a multicore processor, hardwired logic, software stored by a memory device and executed by a microprocessor, firmware, an application specific integrated circuit (ASIC), and/or a field programmable gate array (FPGA). The term “logic” as used herein may include, by way of example, software, hardware, or any combination thereof.

Although specific embodiments have been illustrated and described herein, it will be appreciated by those of ordinary skill in the art that a wide variety of alternate and/or equivalent implementations may be substituted for the specific embodiments shown and described without departing from the scope of the embodiments of the disclosed technology. This application is intended to cover any adaptations or variations of the embodiments illustrated and described herein. Therefore, it is manifestly intended that embodiments of the disclosed technology be limited only by the following claims and equivalents thereof.

What is claimed is:

1. A method of enforcing a virtual corporate boundary, comprising:
a client device of a user requesting sensitive content from a network site on a server device;
the server device determining whether one or both of the user and the client device are permitted to access the sensitive content;
a secure element on the client device establishing a session key between a web application on the server device and a graphics chipset on the client device;
a server application on the server device rendering and encrypting the sensitive content and sending the encrypted rendered content to a browser application on the client device;
an extension of the browser application sending the encrypted rendered content to the graphics chipset; and
the graphics chipset causing a display to visually present the rendered content to the user.

2. The method of claim 1, wherein the secure element establishing the session key comprises the secure element verifying a network site identity of the network site.

3. The method of claim 1, wherein the client device requesting sensitive content is responsive to an interaction between the user and the client device.

4. The method of claim 1, wherein the session key is an ephemeral protected audio/video path (PAVP) session key.

5. The method of claim 1, wherein the secure element establishes the session key over a secure channel using a secret on the client device.

6. The method of claim 1, wherein the graphics chipset comprises a secure sprite generator.

7. The method of claim 1, further comprising the display using high bandwidth digital content protection (HDCP) in connection with visually presenting the rendered content to the user.

8. The method of claim 1, wherein the display is integrated with the client device.

9. The method of claim 1, wherein the client device comprises one of a group consisting of: a laptop computer, a handheld computing device, a tablet computing device, and a smartphone.

10. A method of enforcing a virtual corporate boundary, comprising:
a client device of a user requesting sensitive content from a network site on a server device;
the server device determining whether one or both of the user and the client device are permitted to access the sensitive content;
responsive to a determination that one or both of the user and the client device are permitted to access the sensitive content, the server device sending the sensitive content to the client device;
a secure element on the client device establishing a session key between the secure element and a graphics chipset on the client device;
the secure element rendering and encrypting the sensitive content and sending the encrypted rendered content to the graphics chipset on the client device; and
the graphics chipset causing a display to visually present the rendered content to the user.

11. The method of claim 10, wherein the client device requesting the sensitive content is responsive to an interaction between the user and the client device.

12. The method of claim 10, further comprising the secure element establishing an encrypted channel between a web application on the server device and the secure element.

13. The method of claim 12, wherein the server device sending the sensitive content to the client device comprises the web application sending the sensitive content to the secure element via the encrypted channel.

14. The method of claim 10, wherein the session key comprises a protected audio/video path (PAVP) session key.

15. The method of claim 10, further comprising the display using high bandwidth digital content protection (HDCP) in connection with visually presenting the rendered content to the user.

16. The method of claim 10, wherein the display is integrated with the client device.

17. The method of claim 10, wherein the client device comprises one of a group consisting of: a laptop computer, a handheld computing device, a tablet computing device, and a smartphone.

18. A system, comprising:
a server device configured to execute a server application, store sensitive content, and send the sensitive content over an encrypted channel responsive to a request and affirmative authentication;
a client device configured to run a browser application, the client device comprising:
a secure element configured to establish the encrypted channel between a web application on the server device and the secure element, and receive and encrypt the sensitive content received from the server device over the encrypted channel; and
a graphics chipset configured to receive the encrypted rendered content from the secure element; and
a display configured to visually present the sensitive content to the user responsive to instructions received from the graphics chipset.

19. The system of claim 18, wherein the display is integrated with the client device.

20. The system of claim 18, wherein the display is physically separate from the client device, and wherein the display communicates with the client device over a wireless communication channel.

21. The system of claim 18, wherein the client device comprises one of a group consisting of: a laptop computer, a handheld computing device, a tablet computing device, and a smartphone.
